(19) United States
(12) Patent Application Publication
(10) Pub. No.: US 2008/0036802 A1
(43) Pub. Date: Feb. 14, 2008

(54) LIQUID CONTAINER AND LIQUID CONSUMING APPARATUS

(75) Inventors: Taku Ishizawa, Matsumoto-shi (JP); Satoshi Shinada, Shiojiri-shi (JP)

Correspondence Address: SUGHRUE MION, PLLC, 2100 Pennsylvania Avenue, N.W., Washington, DC, 20037, US

(73) Assignee: Seiko Epson Corporation, Shinjuku-ku (JP)

(21) Appl. No.: 11/835,445

(22) Filed: Aug. 8, 2007

(30) Foreign Application Priority Data
Aug. 8, 2006 (JP) 2006-216111

(51) Int. Cl. B41J 29/38; B41J 2/175

(52) U.S. Cl. 347/6; 347/86

(57) ABSTRACT

A liquid container includes a container body and a memory substrate. The container body stores liquid and is detachably mounted on a liquid consuming apparatus. The memory substrate is provided with a memory chip and is mounted on the container body. Writing and/or reading of information are enabled between the liquid consuming apparatus and the memory chip. The liquid container further includes an oscillator circuit that outputs a signal of prescribed frequency in response to a driving signal from the liquid consuming apparatus.

### BACKGROUND

1. Technical Field

The present invention relates to a liquid container that is detachably mounted on a liquid consuming apparatus and supplies liquid to the liquid consuming apparatus and also to a liquid consuming apparatus on which the liquid container is mounted.

2. Related Art

An ink jet recording apparatus, which is an example of a liquid consuming apparatus, generally supplies ink, which is stored in an ink cartridge mounted on a cartridge mounting portion within the apparatus, to a recording head and the recording head then ejects and applies ink droplets onto a recording medium, such as a sheet of paper, thus performing recording of images or characters.

The recording head of the ink jet recording apparatus controls ejecting of ink droplets by means of heat or vibration. When ink is consumed and the ink cartridge then runs out of ink, a blank ejection, in which ink ejecting operation is performed without supply of ink, occurs. When this blank ejection occurs, it may cause a failure.

Then, the ink jet recording apparatus needs to monitor the residual amount of ink liquid in the ink cartridge to avoid blank ejection of the recording head.

In addition, for example, when conditions of use are different such as when full color photo printing is a major use or when a monochromatic text printing, or the like, is a major use, the colors or amounts of ink liquid consumed are also different. Then, in a recent years, there is an ink jet recording apparatus, in which, depending on conditions of use, portion of a plurality of ink cartridges mounted on the apparatus may be replaced with an ink cartridge that is suitable for the conditions of use. In the case of such an ink jet recording apparatus, it needs to manage usage history, or the like, such as the ink cartridge mounted on the cartridge mounting portion is new or is used before and re-mounted.

In light of the above background, it has been proposed an ink cartridge that is equipped with a memory substrate on the outer surface of a cartridge body that stores ink. The memory substrate includes a memory chip (IC chip) that records information and a circuit connector (contact point) to which an external circuit is connected to the memory chip, which is, for example, described in Japanese Unexamined Patent Application Publication No. 2002-234192.

In this type of ink cartridge, when mounted on the cartridge mounting portion of the ink jet recording apparatus, the memory chip is connected to the control Circuit provided on the side of the ink jet recording apparatus through the contact point of the memory substrate, and then writing and reading of information is enabled between the control circuit provided on the side of the ink jet recording apparatus and the memory chip. Thereafter, the control circuit provided on the ink jet recording apparatus side writes information that indicates the residual amount of ink, usage history, or the like, to the memory chip, so that it is possible to easily manage the residual amount of ink on the side of the recording apparatus.

The control circuit provided on the ink jet recording apparatus side, for example, counts the number of ink droplets that the recording head ejects and, thereby, estimates the amount of ink consumed from the ink cartridge. The control circuit then calculates the updated residual amount of ink on the basis of the amount of ink consumed and the residual amount of ink that is read out from the memory chip, and then updates the residual amount of ink that is recorded in the memory chip.

On the other hand, it has been proposed that a recording apparatus that uses such an ink cartridge, in order to prevent error information from being recorded in the memory chip of the ink cartridge when the control circuit malfunctions due to the influence of a line noise, or the like, that runs in a power supply line, includes an operation stop device that stops operation of the recording apparatus when the amount of noise is larger than a prescribed value, by detecting a noise in power supply voltage by means of a noise sensor, which is, for example, described in Japanese Unexamined Patent Application Publication No. 2005-292673 and Japanese Unexamined Patent Application Publication No. 2002-154223.

However, a noise that influences writing and/or reading of information by means of the control circuit mounted in the recording apparatus is not limited to a line noise of power supply as described in JP-A-2005-292673. When the recording apparatus is, for example, equipped with a xenon lamp, there may be a possibility that the lamp generates a noise and then influences writing and/or reading of information.

In addition, it is impossible for only the noise sensor provided in the recording apparatus to accurately detect a noise over the entire area of the apparatus. For example, when a noise is locally generated around the cartridge mounting portion due to conditions of an ambient environment, or the like, where the recording apparatus is installed, the local noise cannot be detected and, as a result, error information is written in the memory chip due to the influence of noise. This may reduce reliability of management of the subsequent residual amount of ink.

### SUMMARY

An advantage of some aspects of the invention is that it provides a liquid container and a liquid consuming apparatus that, even when a local noise is generated around a liquid container due to conditions of ambient environment where the liquid consuming apparatus is installed, are capable of preventing error information from being written in a memory chip by securely detecting the presence of noise and, thereby, capable of improving reliability of operation management processing based on the information written in the memory chip.

(1) An aspect of the invention provides a liquid container. The liquid container includes a container body and a memory substrate. The container body stores liquid and is detachably mounted on a liquid consuming apparatus. The memory substrate is provided with a memory chip and is mounted on the container body. Writing and/or reading of information are enabled between the liquid consuming apparatus and the memory chip. The liquid container further includes an oscillator circuit that outputs a signal of prescribed frequency in response to a driving signal from the liquid consuming apparatus.

When the above configured liquid container is mounted on the liquid consuming apparatus and the driving signal is generated from the liquid consuming apparatus, the oscillator circuit outputs a signal of prescribed frequency in response to the driving signal. The signal of predetermined frequency that the oscillator circuit outputs at this time will be a composite waveform with an ambient noise. Thus, by comparing the waveform of regular frequency with the composite waveform, it is possible to detect the magnitude of noise around the liquid container. Thus, when a determination circuit that evaluates the output waveform of the oscillator circuit is provided on the liquid consuming apparatus side on which the liquid container is mounted, even when a local noise is generated around the liquid container, it is possible to securely detect the presence of the noise.

(2) In the liquid container according to the above described paragraph (1), the oscillator circuit may be an analog circuit. With this configuration, because the analog circuit is generally more susceptible to the influence of noise than a digital circuit, it is possible to enhance a noise detection sensitivity. Then, when the noise is small enough to not influence the oscillator circuit, that is, the analog circuit, it is possible to accurately write and/or read information without any influence of noise on the memory chip side on which writing and/or reading of information is performed using the digital circuit.

(3) In the liquid container according to the above described paragraph (1) or (2), the oscillator circuit may be mounted on the memory substrate. With such a configuration, because the memory substrate on which the memory chip is mounted is also used for mounting the oscillator circuit, it is possible to reduce costs by reducing the number of components.

(4) In the liquid container according to any one of the above described paragraphs (1) to (3), the oscillator circuit may be a circuit that uses a piezoelectric element. With such a configuration, it is possible to form an analog oscillator circuit with a relatively simple structure.

(5) In the liquid container according to the above described paragraph (4), the oscillator circuit may be provided with an oscillation frequency regulator that regulates oscillation frequency. With such a configuration, when variation occurs in oscillation frequency due to individual difference among various components used in the oscillator circuit, it is possible to eliminate the variation by regulating output frequency by means of the oscillation frequency regulator.

(6) In the liquid container according to the above described paragraph (5), the oscillation frequency regulator may regulate the oscillation frequency by means of liquid having a predetermined physical property, wherein the liquid is stored in a closed space whose open face is sealed with a vibration plate. With such a configuration, because the range of frequency that is regulated by the oscillation frequency regulator is determined on the basis of the density and viscosity of liquid stored in the closed space, it is possible to simply change the range of frequency regulated by replacing the liquid with a liquid that has a different density and/or viscosity.

(7) In the liquid container according to any one of the above described paragraphs (1) to (6), the memory substrate may write and/or read information with the liquid consuming apparatus in a non-contact manner. With such a configuration, in comparison with a case where the memory chip is electrically connected to the liquid consuming apparatus by directly making the contact points to contact each other, it is possible to prevent poor electrical connection from occurring due to the shortage of contact pressure of the contact point by the influence of dimensional tolerance of the container body, or the like.

(8) Another aspect of the invention may provide a liquid consuming apparatus on which the liquid container according to any one of the above described aspects is mounted. The liquid consuming apparatus includes a driving portion, a determination circuit, and a control circuit. The driving portion drives the oscillation circuit by periodically transmitting a driving signal. The determination circuit determines whether distortion of a signal output from the oscillator circuit falls within an allowable range or not. The control circuit executes writing of information to the memory chip only when the determination circuit has determined that the distortion of the signal output from the oscillator circuit falls within the allowable range.

(9) A yet further aspect of the invention provides a memory substrate. The memory substrate used in the liquid container according to any one of the above described paragraphs (1) to (6) may include a group of contact terminals for electrical connection with the liquid consuming apparatus, wherein the contact terminal connected to the oscillator circuit is arranged on an outermost side within the group of contact terminals. With such a configuration, because the contact terminal that is connected to the oscillator circuit is arranged at a position that is maximally susceptible to a disturbance noise, it is possible to securely detect a disturbance noise.

In the above configured liquid consuming apparatus, even when a local noise is generated around the liquid container due to conditions of ambient environment where the liquid consuming apparatus is installed, it is possible to reliably prevent error information from being written in the memory chip due to the influence of noise by securely detecting the presence of the noise.

### BRIEF DESCRIPTION OF THE DRAWINGS

The invention will be described with reference to the accompanying drawings, wherein like numbers reference like elements.

FIG. 1 is a longitudinal cross-sectional view of an ink cartridge, which is a first embodiment of a liquid container according to the invention.

FIG. 2 is a perspective view of a memory substrate that is mounted on the ink cartridge shown in FIG. 1 as viewed from the front face side.

FIG. 3 is a perspective view of the memory substrate shown in FIG. 2 as viewed from the rear face side.

FIG. 4 is a view illustrating an input and output waveform when an oscillator circuit mounted on the memory substrate shown in FIG. 3 is not subject to the influence of noise.

FIG. 5 is a view illustrating an input and output waveform when the oscillator circuit mounted on the memory substrate shown in FIG. 3 is subject to the influence of noise.

FIG. 6 is a longitudinal cross-sectional view of an ink cartridge, which is a second embodiment of the liquid container according to the invention.

FIG. 7 is a block diagram showing connection relationship between a liquid container and a liquid consuming apparatus according to a third embodiment of the invention.

### DESCRIPTION OF EXEMPLARY EMBODIMENTS

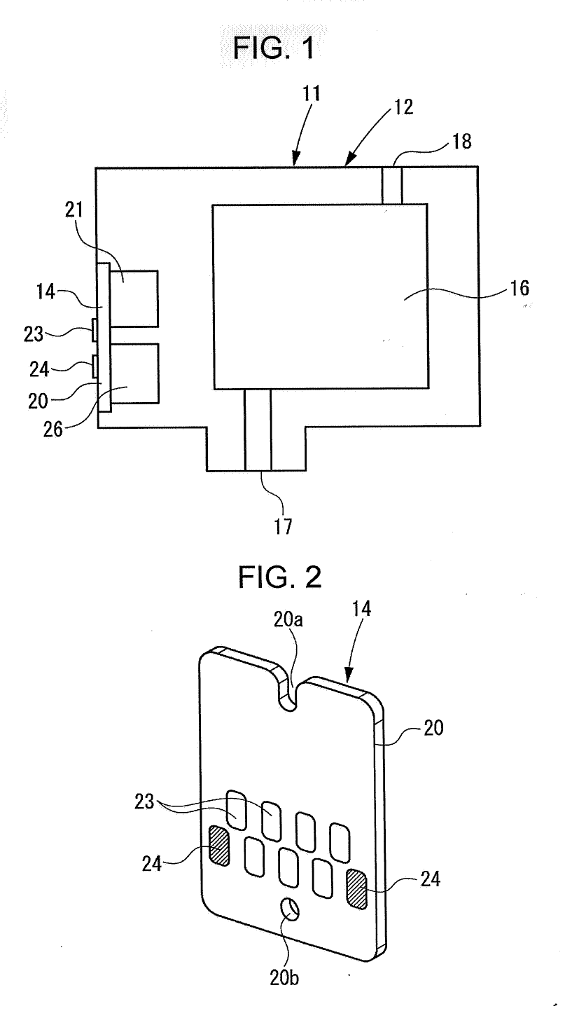

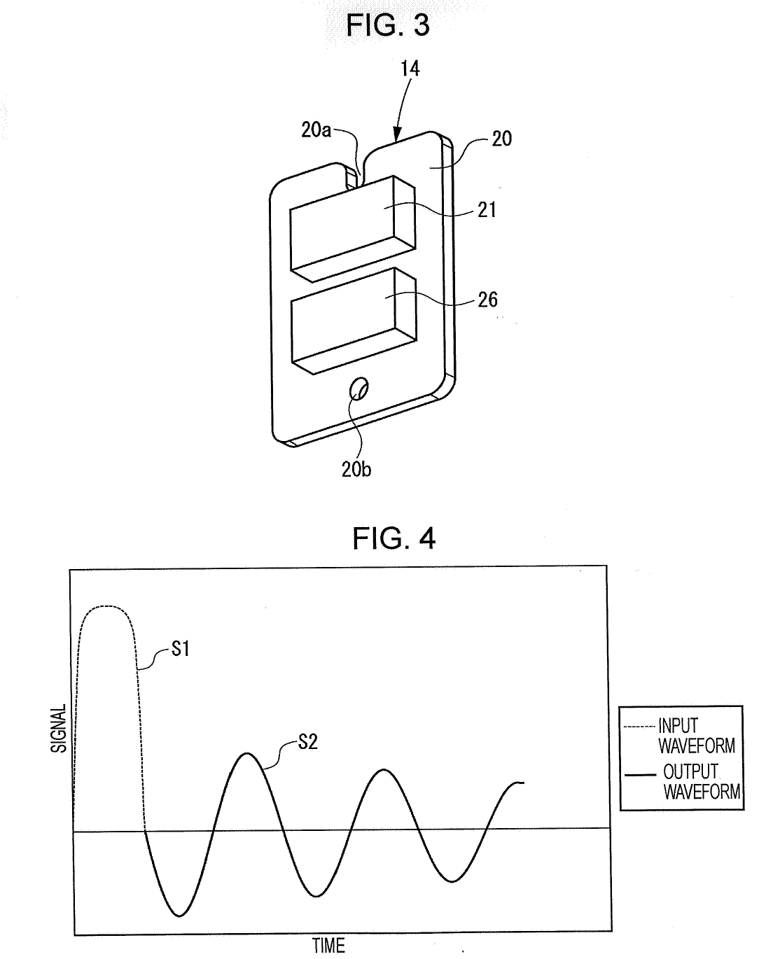

Exemplary embodiments of a liquid container and a liquid consuming apparatus according to the invention will be described with reference to the accompanying drawings. FIG. 1 is a longitudinal cross-sectional view of an ink cartridge, which is a first embodiment of a liquid container according to the invention. FIG. 2 is a perspective view of a memory substrate that is mounted on the ink cartridge shown in FIG. 1 as viewed from the front face side. FIG. 3 is a perspective view of the memory substrate shown in FIG. 2 as viewed from the rear face side.

The ink cartridge 11 of the first embodiment includes a container body 12 and a memory substrate 14. The container body 12 is made of resin and stores ink liquid supplied to a recording head of an ink jet recording apparatus, which is an example of the liquid consuming apparatus. The container body 12 is detachably mounted on a cartridge mounting portion of the ink jet recording apparatus. It can be described that the container body 12 is a part detachably mounted on the cartridge mounting portion. The memory substrate 14 is mounted on the outer wall surface of the container body 12.

The container body 12 includes a liquid storage portion 16 and a liquid supply port 17. The liquid storage portion 16 stores ink liquid supplied to the recording head of the ink jet recording apparatus. The liquid supply port 17 supplies the recording head with ink liquid stored in the liquid storage portion 16. The container body 12 of the present embodiment has an open atmosphere hole 18 formed to introduce outside air into the liquid storage portion 16 in accordance with consumption of ink liquid in the liquid storage portion 16. The liquid supply port 17 is provided to open at the bottom surface of the container body 12. When the container body 12 is mounted on a container mounting portion of the ink jet recording apparatus, an ink supply needle provided on the container mounting portion side is fitted in the liquid supply port 17, so that ink liquid in the liquid storage portion 16 is ready to be supplied toward the recording head side.

The memory substrate 14 includes a plate-like printed circuit board 20, a memory chip 21, and a circuit connector 23. The memory chip 21 is mounted on the rear face of the printed circuit board 20 and records information. The circuit connector 23 is used for connecting an external circuit to the memory chip 21. The memory substrate 14 is fixed to the outer wall surface of the container body 12 through fitting holes 20a, 20b, which are formed in the upper side and lower side of the printed circuit board 20, so that the memory substrate 14 is mounted on the outer wall surface of the container body 12.

In the case of the present embodiment, the circuit connector 23, when the container body 12 is mounted on the container mounting portion of the ink jet recording apparatus with a plurality of contact points formed by printing on the surface of the printed circuit board 20, is pressed to contact terminals provided on the container mounting portion side, so that the control circuit mounted on the ink jet recording apparatus side is electrically connected to the memory chip 21.

That is, the ink cartridge 11 of the present embodiment, when the container body 12 is mounted on the container mounting portion of the recording apparatus, is able to write and/or read information with the control circuit provided on the ink jet recording apparatus side connected to the memory chip 21 through the memory chip 21 and the circuit connector 23.

In the case of the present embodiment, an oscillator circuit 26 is mounted on the rear face of the printed circuit board 20 that forms the memory substrate 14 and outputs a signal of prescribed frequency in response to a driving signal output from a driving circuit of the ink jet recording apparatus side. The memory chip 21 is a digital circuit that executes writing and/or reading of a digital signal. The oscillator circuit 26 is an analog circuit that is formed of circuit elements, such as a coil and a capacitor, and outputs an analog signal of prescribed frequency.

The oscillator circuit 26 is connected the control circuit of the ink jet recording apparatus side through a plurality of contact points 24, which are circuit connectors, provided on the front face of the printed circuit board 20. As shown in FIG. 4, when the oscillator circuit 26 receives an input wave S1, which is a driving signal output from the driving circuit of the ink jet recording apparatus side, the oscillator circuit 26 outputs a prescribed output waveform (sinusoidal wave) S2, which is an analog signal of prescribed frequency that is set in advance. The contact points 24 are arranged outside the contact points 23.

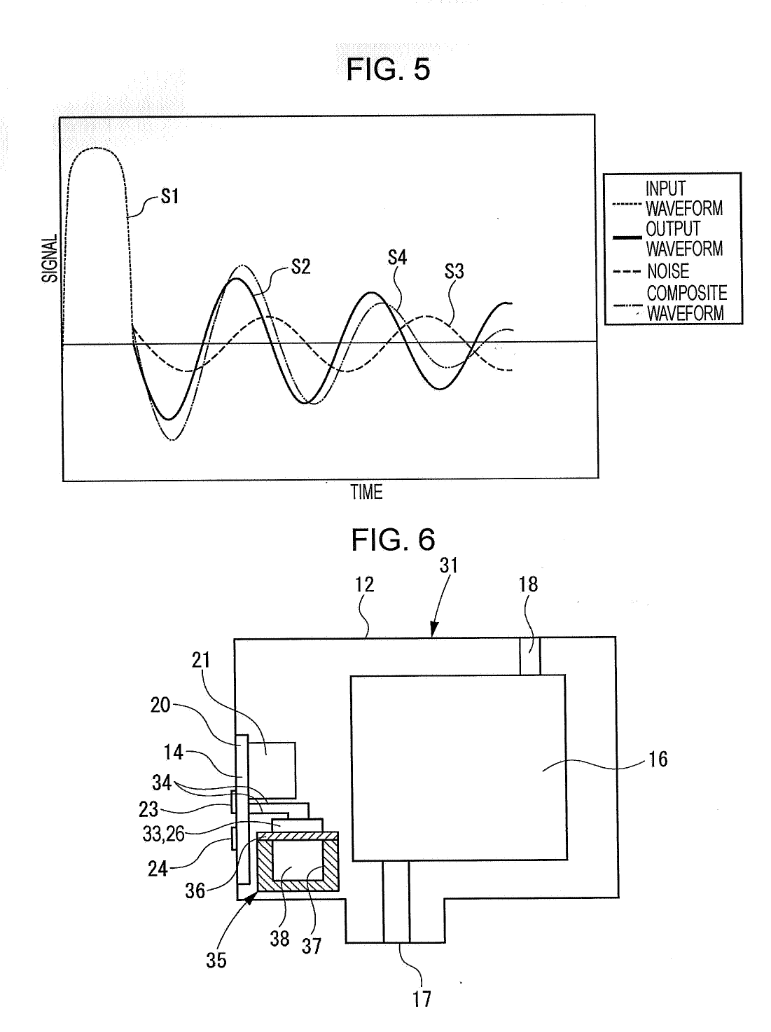

When the oscillator circuit 26 outputs the output waveform S2, if a noise is applied around the ink cartridge 11, an actual output from the oscillator circuit 26 is subject to the influence of noise and, as shown in FIG. 5, becomes a composite waveform S4 which is obtained by combining the prescribed output waveform S2 with a noise waveform S3, thus becoming a signal having distortion in waveform.

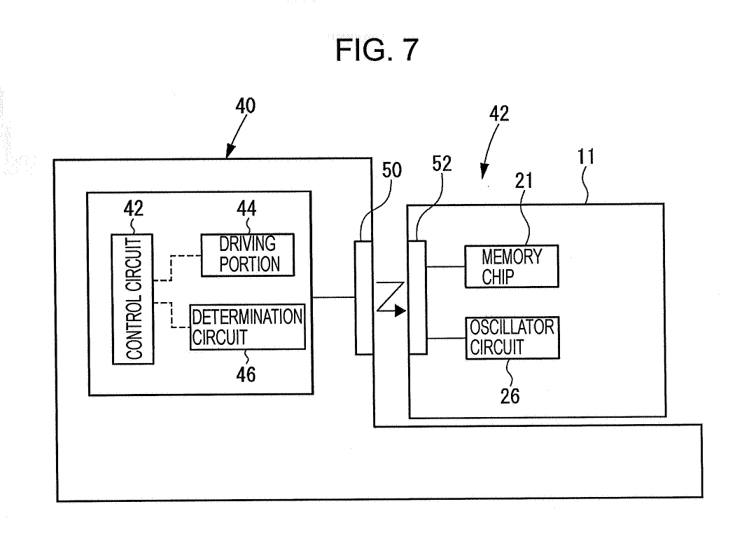

The ink jet recording apparatus on which the ink cartridge 11 is mounted, as shown in FIG. 7, which will be described later, includes a driving portion 44 and a determination circuit 46. The driving portion 44 drives the oscillator circuit 26 by periodically transmitting the input wave S1 as a driving signal shown in FIG. 4. The determination circuit 46 determines whether the distortion of the signal output from the oscillator circuit 26 falls within an allowable range or not. Then, the control circuit 42 connected to the memory chip 21, only when the determination circuit 46 has determined that the distortion of the signal output from the oscillator circuit 26 falls within the allowable range, executes writing of information to the memory chip 21. The information that the control circuit 42 of the ink jet recording apparatus 40 writes to and/or reads from the memory chip 21 is information such as the residual amount of ink or usage history.

In the ink cartridge 11 of the present embodiment, when mounted to the container mounting portion of the ink jet recording apparatus and a driving signal is generated from the ink jet recording apparatus side, the oscillator circuit 26 outputs a signal of prescribed frequency in response to the driving signal. Then, the signal of prescribed frequency that the oscillator circuit outputs becomes a composite signal S4 that is combined with an ambient noise as shown in FIG. 5. Thus, by comparing the regular frequency waveform S2 with the composite waveform S4, it is possible to detect the magnitude of nose around the ink cartridge 11. Accordingly, by providing the determination circuit that evaluates an output waveform of the oscillator circuit 26 on the ink jet recording apparatus side on which the ink cartridge 11 is mounted as described above, even when a local noise is generated around the ink cartridge 11 due to conditions of ambient environment where the ink jet recording apparatus is installed, it is possible to reliably prevent error information from being written in the memory chip 21 due to the influence of noise by securely detecting the presence of the noise, and it is possible to improve reliability of operation management processing based on the information written in the memory chip 21.

In addition, the ink cartridge 11 of the present embodiment is configured so that the oscillator circuit 26 is an analog circuit. In general, the analog circuit is more susceptible to the influence of noise than the digital circuit, so that it is possible to enhance noise detection sensitivity. Then, when the noise is small enough to not influence the oscillator circuit 26, that is, the analog circuit, it is possible to accurately write and/or read information without any influence of noise on the side of the memory chip 21 on which writing and/or reading of information is performed using the digital circuit. it is possible to improve reliability of operation management processing based on the information written in the memory chip 21. In addition, the contact points 24 that are connected to the oscillator circuit 26 in the memory substrate 14 of the present embodiment are arranged outside the contact points 23 that are connected to the memory chip 21. Therefore, the contact points 24 are more susceptible to a disturbance noise than the contact points 23, so that it is possible to securely detect the disturbance noise.

Furthermore, in the ink cartridge 11 of the present embodiment, the memory substrate 14 on which the memory chip 21 is mounted is also used for mounting the oscillator circuit 26, so that it is unnecessary to provide an additional exclusive circuit board for mounting the oscillator circuit 26. Thus, it is possible to avoid an increase in number of circuit boards mounted on the container by the addition of the oscillator circuit 26, so that it is possible to reduce costs by reducing the number of components.

FIG. 6 is a longitudinal cross-sectional view of an ink cartridge, which is a second embodiment of the liquid container according to the invention. The ink cartridge 31 according to the second embodiment includes the container body 12 that stores ink liquid and the memory substrate 14 that is mounted on the outer wall surface of the container body 12, as in the case of the first embodiment. The same reference numerals denote the same components as those of the first embodiment.

The feature of the present embodiment is that the oscillator circuit 26 is a circuit that uses a piezoelectric element 33 and an oscillation frequency regulator 35 is provided for regulating oscillation frequency. The piezoelectric element 33 is connected to the contact points 24 formed on the printed circuit board 20 by means of a conductive device 34, such as a lead wire, and is connected to the control circuit provided on the ink jet recording apparatus through the contact points 24. The piezoelectric element 33, in response to a driving signal output from the driving portion of the ink jet recording apparatus side, outputs a signal of prescribed frequency that is set in advance.

The oscillation frequency regulator 35 regulates the oscillation frequency by means of the amount, density, viscosity, or the like, of liquid 38 having a predetermined physical property, which is stored in the closed space 37 whose open face is sealed with a vibration plate 36. Also, the vibration plate 36 is facing the space 37.

In the ink cartridge 31 according to the second embodiment, because the oscillator circuit 26 employs a circuit that uses the piezoelectric element 33, it is possible to form an analog oscillator circuit with a relatively simple structure.

In addition, in the ink cartridge 31 of the present embodiment, because the oscillator circuit 26 is provided with the oscillation frequency regulator 35 that regulates oscillation frequency, when variation occurs in oscillation frequency due to individual difference among various components used in the oscillator circuit 26, it is possible to eliminate the variation by regulating output frequency by means of the oscillation frequency regulator 35. It is possible to detect the level of noise with high accuracy without any influence of the variation.

Furthermore, in the ink cartridge 31 of the present embodiment, because the oscillation frequency regulator 35 regulates oscillation frequency by means of the amount, density, viscosity, or the like, of liquid 38 having a predetermined physical property, which is stored in the closed space 37 whose open face is sealed with a vibration plate 36, it is possible to simply change the range of frequency regulated, and it is easy to change the range of frequency regulated.

Note that, in the above described embodiments, the memory chip 21 mounted on the memory substrate 14 is connected to the control circuit provided on the ink jet recording apparatus side so that the circuit connectors 23, serving as the contact points, are pressed to directly contact the contact terminal provided on the recording apparatus side. However, the circuit connectors 23 of the memory substrate 14 may be modified as shown in FIG. 7, in which transmitting and receiving antennas 50, 52 that are each connected to an transmitting and receiving circuit (not shown) are respectively provided in the ink jet recording apparatus 40 and in the ink cartridge 11 that is mounted on the container mounting portion 42 of the recording apparatus 40, and the memory chip 21 is connected to the control circuit 42 provided on the side of the recording apparatus 40 through a wireless communication system in a non-contact manner.

With such a configuration, in comparison with the memory chip 21 is electrically connected to the control circuit provided on the side of the ink jet recording apparatus by directly contacting the contact points each other, it is possible to prevent poor electrical connection from occurring due to the shortage of contact pressure of the contact point by the influence of dimensional tolerance of the container body 12 or container mounting portion 42.

Note that applications of the liquid container according to the aspect of the invention are not limited to the ink cartridge according to the above described embodiments. In addition, the liquid consuming apparatus that is provided with the container mounting portion on which the liquid container according to the aspect of the invention is also not limited to ink jet recording apparatus according to the above described embodiments. The liquid consuming apparatus includes various types of apparatus that is provided with a container mounting portion on which a liquid container is detachably mounted and that supplies the apparatus with liquid stored in the liquid container. Specifically, the liquid consuming apparatus, for example, includes an apparatus provided with a color material ejecting head used for manufacturing a color filter for a liquid crystal display, an apparatus provided with an electrode material (conductive paste) ejecting head used for forming an electrode for an organic EL display or a field emission display (FED), an apparatus provided with a bio-organic material ejecting head used for manufacturing a bio-chip, or an apparatus provided with a sample ejecting head that ejects a sample as a precision pipette.

What is claimed is:

1. A liquid container comprising:
a container body that stores liquid and is detachably mounted on a liquid consuming apparatus;
a memory substrate that is provided with a memory chip and is mounted on the container body, wherein writing and/or reading of information is enabled between the liquid consuming apparatus and the memory chip; and
an oscillator circuit that outputs a signal of prescribed frequency in response to a driving signal from the liquid consuming apparatus.

2. The liquid container according to claim 1, wherein the oscillator circuit is an analog circuit.

3. The liquid container according to claim 1, wherein the oscillator circuit is mounted on the memory substrate.

4. The liquid container according to claim 1, wherein the oscillator circuit is a circuit that uses a piezoelectric element.

5. The liquid container according to claim 4, wherein the oscillator circuit is provided with an oscillation frequency regulator that regulates oscillation frequency.

6. The liquid container according to claim 5, wherein the oscillation frequency regulator regulates the oscillation frequency by means of liquid having a predetermined physical property, wherein the liquid is stored in a closed space whose open face is sealed with a vibration plate.

7. The liquid container according to claim 1, wherein the memory substrate writes and/or reads information with the liquid consuming apparatus in a non-contact manner.

8. A liquid consuming apparatus on which the liquid container according to claim 1 is mounted, comprising:
a driving portion that drives the oscillation circuit by periodically transmitting a driving signal;
a determination circuit that determines whether distortion of a signal output from the oscillator circuit falls within an allowable range or not; and
a control circuit that executes writing of information to the memory chip only when the determination circuit has determined that the distortion of the signal output from the oscillator circuit falls within the allowable range.

9. A memory substrate used in the liquid container according to claim 1, comprising:
a group of contact terminals for electrical connection with the liquid consuming apparatus, wherein the contact terminal connected to the oscillator circuit is arranged on an outermost side within the group of contact terminals.
